(19) United States
(12) Patent Application Publication
(10) Pub. No.: US 2007/0262488 A1
(43) Pub. Date: Nov. 15, 2007

(54) Friction weld of two dissimilar materials

(75) Inventor: Hung Chih Chen, Sunnyvale, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/430,760

(22) Filed: May 9, 2006

(51) Int. Cl. B29C 65/06; B32B 37/06

(52) U.S. Cl. 264/249; 156/73.5; 156/73.6; 156/308.2

(57) ABSTRACT

The present invention relates to a method for joining two vastly dissimilar materials. One embodiment provides a method for joining two materials. The method comprises generating a relative motion between a first material and a second material while pressing the first material against the second material, wherein the first material is non-metallic and the second material is metal, and holding the first material against the second material without relative motion to form a mechanical joint between the first and second materials.

### BACKGROUND OF THE INVENTION

1. Field of the Invention

Embodiments of the invention generally relate to a method for joining two dissimilar materials together. Embodiments of the invention specifically relate to a retaining ring for retaining a substrate and a method of making the retaining ring.

2. Description of the Related Art

Sub-micron multi-level metallization is one of the key technologies for the next generation of ultra large-scale integration (ULSI). The multilevel interconnects that lie at the heart of this technology require planarization of interconnect features formed in high aspect ratio apertures, including contacts, vias, trenches and other features. Reliable formation of these interconnect features is very important to the success of ULSI and to the continued effort to increase circuit density and quality on individual substrates and die.

Planarization is generally performed using Chemical Mechanical Polishing (CMP) and/or Electro-Chemical Mechanical Deposition (ECMP). A planarization method typically requires that a substrate be mounted in a carrier head, with the surface of the substrate to be polished exposed. The substrate supported by the carrier head is then placed against a rotating polishing pad. The carrier head holding the substrate may also rotate, to provide additional motion between the substrate and the polishing pad surface. A polishing solution is generally provided to the polishing pad and the substrate to promote chemical and/or mechanical polishing.

During planarization, a substrate is typically mounted on the carrier head within a retaining ring. The retaining ring is configured to keep the substrate from slipping away during mounting or polishing and keep the polishing pad flat near the edge of the substrate so that the substrate is polished evenly. This requires the retaining ring to have a generally rigid structure. Since the retaining ring also in contact with the polishing pad and the polishing solution, it is necessary for at least part of the retaining ring to be resistive to wear from the polishing pad and the chemicals in the polishing solution.

To meet these requirements, a retaining ring generally comprises two sections made of two dissimilar materials: a polymer section for wear and chemical resistance and a metal section for rigidity. An epoxy bond is generally used to join the plastic section and the metal section in the state of the art retaining ring. However, there are several disadvantages for the epoxy bond. The epoxy bond is very sensitive to temperature and may become delaminated during certain processes when temperature elevates. The epoxy bond also fatigues with cyclic load, thus, limiting the lifetime of the retaining ring. The chemical compatibility of the epoxy bond with the polishing solution is unknown because the formation of epoxy bond is a trade secret for the supplier. If the polishing solution attacks the epoxy bond, the epoxy bond may be weakened and contamination may also be generated. The curing of the epoxy bond usually takes 5 days resulting in high manufacturing cost. Also, mixing and application of the epoxy bond requires skilled labor and leaves room for human error.

Therefore, there is a need for methods to improve the bonding between two dissimilar materials in a retaining ring and other applications.

### SUMMARY OF THE INVENTION

Embodiments of the invention generally relate to using friction weld to join two dissimilar materials together. Embodiments of the invention specifically relate to a retaining ring comprising a mechanical bond and a method of making the retaining ring.

One embodiment provides a method for joining two materials. The method comprises generating a relative motion between a first material and a second material while pressing the first material against the second material, wherein the first material is non metallic and the second material is metal, and holding the first material against the second material without relative motion to form a mechanical joint between the first and second materials.

Another embodiment provides a method for making a retaining ring. The method comprises providing a first annular portion comprising a first material, providing a second annular portion comprising a second material, wherein the first material is non metallic and the second material is metal, generating a relative motion between the first and second annular portion while pressing the first annular portion against the second annular portion, and holding the first annular portion against the second annular portion without relative motions to form a mechanical joint between the first and second annular portions.

Yet another embodiment provides a retaining ring. The retaining ring comprises a first annular portion made from a first material, and a second annular portion made from a second material, wherein the first annular portion and the second annular portion are bond together with a mechanical joint, the first material and the second material is vastly dissimilar.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1C illustrate a process of frictional welding two dissimilar materials in accordance with one embodiment of the present invention.

FIG. 2A illustrates a partial perspective view of a material with surface pattern to be frictional welded together in accordance with one embodiment of the present invention.

FIG. 2B illustrates a partial perspective view of a two piece retaining ring in accordance with one embodiment of the present invention.

FIG. 3A illustrates a partial perspective view of a material with surface pattern to be frictional welded together in accordance with one embodiment of the present invention.

FIG. 3B illustrates a partial perspective view of a two piece retaining ring in accordance with one embodiment of the present invention.

### DETAILED DESCRIPTION

The present invention provides embodiments of retaining ring manufactured from two dissimilar materials frictional welded together and method of frictional welding of two vastly different materials. The two materials are pressed together while relative motions between the two materials generate frictional heat to locally melt one material. When the relative motion stops, a mechanical joint is formed between the two materials.

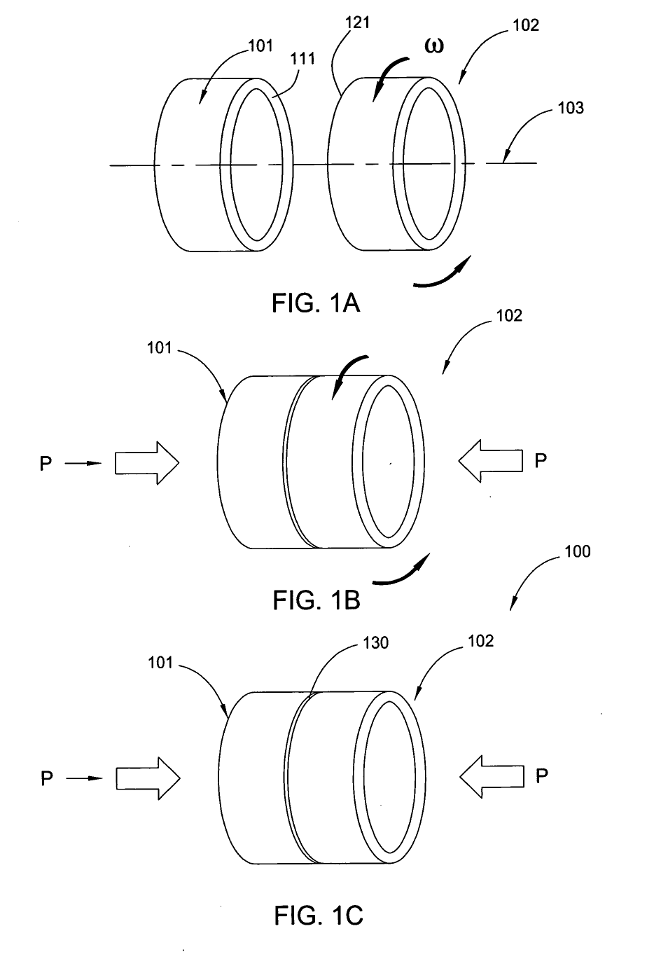

FIGS. 1A-1C illustrate a process of frictional welding two dissimilar materials in accordance with one embodiment of the present invention.

FIG. 1A illustrates a non reactive ring 101 made and a rigid ring 102 to be joined together to form a retaining ring. The non reactive ring 101 and the rigid ring 102 are generally made of dissimilar materials, for example the non reactive ring 101 may be made from a non metallic material and the rigid ring 102 may be made from a metal. In one embodiment, the non reactive ring 101 may be made of a polymer material which is resistive to wear and chemicals, for example, polyphenylene sulfide (PPS), polyetheretherketone (PEEK), carbon filled PEEK, Teflon® filled PEEK, polyethylene terephthalate (PET), polybutylene terephthalate(PBT) polytetrafluoroethylene (PTFE), polybenzimidazole (PBI), polyetherimide (PEI), or a composite material. The rigid ring 102 may be made of a metal, for example, stainless steel, molybdenum, or aluminum, to provide rigidity the retaining ring. To join the non reactive ring 101 and the rigid ring 102 together, a joint surface 111 of the non reactive ring 101 is facing a joint surface 121 of the rigid ring 102, and center axis of the non reactive ring 101 and the rigid ring 102 coincide with a common axis 103.

In one embodiment, the rigid ring 102 is rotated about the common axis 103 at an angular rate w and at least one of the rigid ring 102 or the non reactive ring 101 is moved along the common axis 103 so that the joint surface 111 of the non reactive ring 101 is in solid contact with the joint surface 121 of the rigid ring 102, as shown in FIG. 1B. A pressing force P is applied to press the joint surface 111 of the non reactive ring 101 against the joint surface 121 of the rigid ring 102 while the rigid ring 102 rotates with the angular rate w and the non reactive ring 101 is held stationary, generating a relative motion between the non reactive ring 101 and rigid ring 102. The relative motion generates frictional heat between the joint surface 111 of the non reactive ring 101 and the joint surface 121 of the rigid ring 102 eventually melts a layer of the non reactive ring 101, which generally has a lower melting point. The relative motion may be stopped when enough material has been melted. The pressing force P sustains after the relative motion has stopped until the melted material solidifies and a mechanical joint 130 forms between the non reactive ring 101 and the rigid ring 102, as shown in FIG. 1C. It generally takes a few seconds for the mechanical joint 130 to harden and takes the geometry of the unmelted ring. The non reactive ring 101 and the rigid ring 102 are now permanently welded together.

It should be noted that the relative motion in FIGS. 1A-1C may also be produced by rotating the non reactive ring 101 and holding the rigid ring 102 stationary, or rotating both the non reactive ring 101 and the rigid ring 102 at different angular rates. In one embodiment, the angular rate ω of the rigid ring 102 may be up to about 600 RPM. In one embodiment, the amplitude of the pressing force P may be controlled by displacement of the non reactive ring 101 and/or the rigid ring 102. Whether or not enough material has been melted for the formation of the mechanical joint 130 may be decided by the amplitude of the pressing force P, the angular rate ω and the duration of the relative motion. The duration of the relative motion is relative short, at about 2 seconds to join a retaining ring.

It should be noted that the relative motion may also be a linear motion or vibration. The method for joining two vastly dissimilar materials may be used to join any structure that may be formed by two vastly different materials.

Further machining may be performed to the joined non reactive ring 101 and rigid ring 102 to reach final dimension and designed structure for a retaining ring. Detailed description of a retaining ring may be found in U.S. Pat. No. 6,974,371, and U.S. patent application Ser. No. 10/659,047, which are incorporated herein as references.

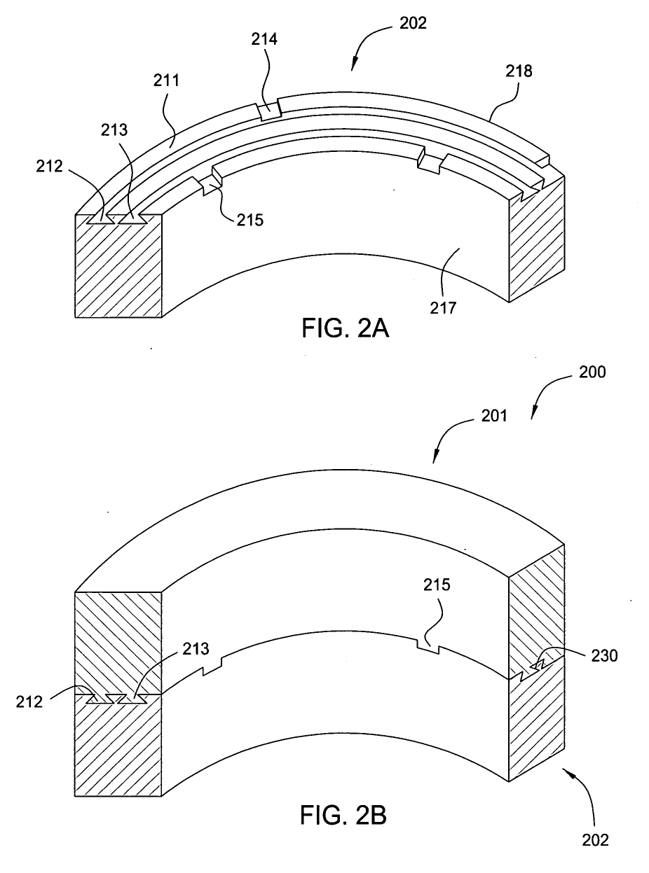

FIG. 2A illustrates a partial perspective view of a rigid ring 202 in accordance with one embodiment of the present invention. The rigid ring 202 is similar to the rigid ring 102 of FIGS. 1A-1C and is configured to be frictional welded together with a non reactive ring to form a retaining ring. Circular grooves 212 and 213 are formed on a top surface 211 of the rigid ring 202. The circular grooves 212 and 213 are concentric and have dovetailed cross sections to form an interlocked mechanical joint with a non reactive ring. A plurality of radial openings 214 and a plurality of radial openings 215 are formed on the top surface 211. Each of the plurality of radial openings 214 is open to an outer surface 218 of the rigid ring 202 and the circular groove 212. Each of the plurality of radial openings 215 is open to an inner surface 217 of the rigid ring 202 and the circular groove 213. The radial openings 214 and 215 are configured to prevent generating air bubbles during frictional welding by providing out flowing paths for the air in the circular grooves 212 and 213. In one embodiment, the radial openings 214 and 215 may also have dovetailed cross sections to form an interlocked mechanical joint with a non reactive ring.

In one embodiment, the circular grooves 212 and 213 may have a thickness of about 0.1 inch. In another embodiment, more or less circular grooves may be formed on the top surface 211. In case of more than two concentric circular grooves formed on the top surface 211, inner radial openings may be formed between the inner circular groove and a neighboring groove, which is eventually connected to the outer surface 218 or the inner surface 217.

FIG. 2B illustrates a partial perspective view of a retaining ring 200 formed by the rigid ring 202 of FIG. 2A and a non reactive ring 201 in accordance with one embodiment of the present invention. The non reactive ring 201 is similar to the non reactive ring 101 of FIGS. 1A-1C. The non reactive ring 201 and the rigid ring 202 are joined together by a frictional welding method of the present invention, such as the method described in FIGS. 1A-1C. In this configuration, a top layer of the non reactive ring 201 melted and filled in the surface features, including the circular grooves 212 and 213, and the plurality of radial openings 214 and 215. A mechanical joint 230 is formed between the rigid ring 202 and the non reactive ring 201. The dovetailed circular grooves 212 and 213 provide the mechanical joint 230 an interlocked structure for an improved mechanical structure.

Mechanical joints formed using the method of the present invention, such as the mechanical joints 130 of FIG. 1C and the mechanical joints 230 of FIG. 2B, have several advantages. First, the cost of manufacturing the mechanical joints is low since it takes only seconds to complete. Second, temperature and chemical degradation is avoided since the mechanical joints are formed by mechanical interlocking features. Third, human errors may be eliminated since the friction weld method may be automated easily.

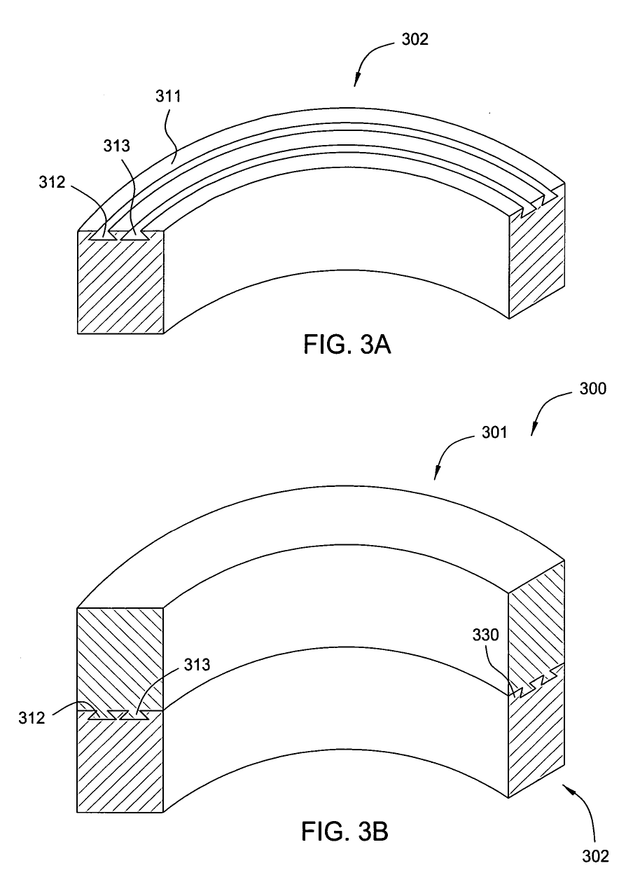

FIG. 3A illustrates a partial perspective view of a rigid ring 302 in accordance with one embodiment of the present invention. The rigid ring 302 is similar to the rigid ring 202 of FIG. 2A except that the rigid ring 302 does not have radial openings connected to circular grooves 312 and 313 formed on a top surface 311. FIG. 3B illustrates a partial perspective view of a retaining ring 300 formed by the rigid ring 302 of FIG. 3A and a non reactive ring 301 in accordance with one embodiment of the present invention. The non reactive ring 301 and the rigid ring 302 are joined together to form a mechanical joint 330 by a frictional welding method of the present invention, such as the method described in FIGS. 1A-1C.

It should be noted that the method of the present invention may be used to join any structures formed by two dissimilar materials. Parameters of the relative motion, amplitude and duration of the pressing force, and surface features may be chosen according to the structure and material involved.

While the foregoing is directed to embodiments of the present invention, other and further embodiments of the invention may be devised without departing from the basic scope thereof, and the scope thereof is determined by the claims that follow.

What is claimed is:

1. A method for joining two materials, comprising:
generating a relative motion between a first material and a second material while pressing the first material against the second material, wherein the first material is non-metallic and the second material is metal; and
holding the first material against the second material without relative motion to form a mechanical joint between the first and second materials.

2. The method of claim 1, further comprising stopping the relative motion after a layer of the first material melts, wherein the first material has a lower melting point than the second material.

3. The method of claim 1, wherein the first material is polymer.

4. The method of claim 3, wherein the second material is stainless steel.

5. The method of claim 1, the relative motion is at least one of a linear, circular or vibratory motion.

6. The method of claim 1, further comprising:
forming surface features on the second material; wherein the second material has a higher melting point than the first material and the surface features on the second material are pressed against the first material.

7. The method of claim 6, wherein the mechanical joint comprises the first material filling in the surface features on the second material.

8. A method for making a retaining ring, comprising:
providing a first annular portion comprising a first material;
providing a second annular portion comprising a second material, wherein the first material is non-metallic and the second material is metal;
generating a relative motion between the first and second annular portion while pressing the first annular portion against the second annular portion; and
holding the first annular portion against the second annular portion without relative motions to form a mechanical joint between the first and second annular portions.

9. The method of claim 8, wherein the relative motion is a circular motion.

10. The method of claim 9, wherein generating the relative motion comprises:
rotating the first annular portion about a center axis; and
holding the second annular portion stationary.

11. The method of claim 9, wherein generating the relative motion comprises:
rotating the first annular portion about a center axis at a first speed; and
rotating the second annular portion about the center axis at a second speed, wherein the first speed is different from the second speed.

12. The method of claim 8, further comprising stopping the relative motion after a layer of the first material melts, wherein the first material has a lower melting point than the material.

13. The method of claim 8, further comprising generating surface features on a top surface of the second annular portion, wherein the top surface is configured to be pressed against the first annular portion.

14. The method of claim 13, wherein the surface features comprise one or more circular grooves each having a dovetailed cross section.

15. The method of claim 8, further comprising:
forming surface features on the second annular portion, wherein the second material has a higher melting point than the first material and the surface features on the annular portion are pressed against the first annular portion.

16. The method of claim 15, wherein the mechanical joint comprises the first material filling in the surface features on second annular portion.

17. A retaining ring comprising:
a first annular portion made from a first material; and
a second annular portion made from a second material, wherein the first annular portion and the second annular portion are bonded together with a mechanical joint, the first material is a metal and the second material is a polymer.

18. The retaining ring of claim 17, wherein the first material is stainless steel and the second material is plastic.

19. The retaining ring of claim 17, wherein the mechanical joint is formed by filling second material in one or more circular grooves of the first material.

20. The retaining ring of claim 19, wherein one or more circular grooves are connected to one or more radial openings.
